(19) United States
(12) Patent Application Publication
(10) Pub. No.: US 2005/0036262 A1
(43) Pub. Date: Feb. 17, 2005

(54) DC Voltage surge suppressor with distributed capacitance EMI filtering and impedance matching

(76) Inventors: Fred Mac Siebenthall, Honey Grove, TX (US); James Michael Gentry, Leonard, TX (US); Alvin Wright Woods III, Ravenna, TX (US); Brent Monroe Green, Ector, TX (US); Ronald William Glaser, Ector, TX (US); Ronald Mel Hander, Denison, TX (US)

Correspondence Address: Philmore H. Colburn II;Cantor Colburn LLP, 55 Griffin Road South, Bloomfield, CT, 06002, US

(21) Appl. No.: 10/616,753

(22) Filed: Jul. 9, 2003

(51) Int. Cl. H02H 1/00

(52) U.S. Cl. 361/118

(57) ABSTRACT

An electromagnetic interference filter and surge suppression apparatus comprising: a first filter operably connected in series with the first power input terminal and a first output terminal and an impedance comprising a first conductor on a first layer of a circuit card forming a distributed inductance in series with the second filter, the impedance also including a second conductor on a second layer of the circuit card operably connected to a ground, the first conductor and the second conductor forming a distributed capacitance.

### BACKGROUND OF THE INVENTION

The invention relates generally to methods and apparatus for suppressing transient voltages and Electromagnetic Interference (EMI) voltages, on power supply input lines. All electronic equipment includes a power input that is connected to common power source or bus. These power sources or busses may be susceptible to power transients and/or other interference. For example, a power that line may be carrying radio frequency (RF) signals to voltage-sensitive equipment. In order to protect voltage-sensitive equipment from damage caused by EMI and voltage transient surges, an EMI filter with a surge suppressor, sometimes also referred to as a surge arrestor or protector, is in the power line inserted between a source and the equipment. An EMI filter operates to prevent high frequency interference commonly referred to as radio frequency interference (RFI), from entering on the power line. Likewise, the EMI filter may also operate to prevent RF energy from being radiated by the equipment. In addition, there may be present on a voltage source, surges, transients, and spikes that could be harmful to downstream electronic equipment utilizing the incoming power. Surge suppressors or arrestors are commonly employed to shunt or discharge to ground high such voltage transients and thereby prevent damage. Examples of suppressors include, but are not limited to transorbs, transient suppression diodes, metal oxide varistors (MOV), air gap devices and the like.

A deterministic input impedance for the EMI filter and suppression devices is desirable so that filtering may be employed that ensures attenuation at the intended frequencies while not attenuating signals at desired frequencies. The impedances inherent in the conductors in each EMI filter configuration depend on the physical geometry of the conductors and the other components within the filter. The impedances will tend to vary between filters due to the difficulty of precisely reproducing the physical layout of the units. Thus, tuning not only must take into account the variations in the inherent impedance of the components, but also the natural variations in the parasitic impedances of the conductors. The impedances of the conductors, capacitors, inductors and the suppression devices of an EMI filter are tuned so that the entire circuit matches the characteristic impedance of the power line at the desired operational frequencies, thus assuring minimal loss or attenuation of the signals traveling through the unit along the transmission line. Generally, in power applications, the desired frequency is low or a DC application. All suppression devices and EMI filters have associated with them parasitic capacitances and inductances that tend to modify the impedance of the power line, especially at high frequencies.

The EMI filters and surge suppressor of the existing art suffer from several problems. First, the utilization of numerous discrete components adds difficulty and cost to fabrication. Second, utilization of either point-to-point hand wiring techniques or standard printed circuit board design employing crimped or connectorized cables with discrete components results in increased contact resistance and unpredictable filtering response due to stray lead inductance and capacitance. Third, employing crimped or soldered conductors results in unpredictable fabrication variation that yields inherent impedance mismatches causing poor circuit performance along with increased operating temperature due to contact resistance impacts input and output impedance.

### SUMMARY OF INVENTION

The above discussed and other drawbacks and deficiencies are overcome or alleviated by an electromagnetic interference filter and surge suppression apparatus comprising: a first filter with a first end and a second end, the first end operably connected in series with the first power input terminal, the second end operable connected to a first output terminal; and an impedance comprising a first conductor on a first layer of a circuit card forming a distributed inductance in series with the second filter, the impedance also including a second conductor on a second layer of the circuit card operably connected to a ground, the first conductor and the second conductor forming a distributed capacitance. The impedance is configured to facilitate matching of an input impedance of the electromagnetic filter with that of a voltage source.

In another exemplary embodiment the apparatus may include a second filter operably connected to the first power input terminal and ground. The second filter may include a first capacitor and a second capacitor, each capacitor with a first end and a second end, wherein the first end of the first capacitor is operably connected to the first power input terminal and the second end is operably connected to ground. The first end of the second capacitor is operably connected to the second power input terminal and the second end is operably connected to ground.

In yet another embodiment, the apparatus may also includes a third filter also with a first end and a second end, the first end operably connected in series with the second power input terminal and the second end in operable connected to a second output terminal.

Moreover, the apparatus may further include a fourth filter comprising a fourth capacitor and a fifth capacitor, each capacitor with a first end and a second end, wherein the first end of the fourth capacitor is operably connected to the first output terminal and the second end operably connected to a chassis ground and wherein the first end of the fifth capacitor is operably connected to the second output terminal and the second end is operably connected to a chassis ground.

Also disclosed, in yet another exemplary embodiment is a method of filtering and matching impedance in a power line electromagnetic interference filter and surge suppression apparatus comprising: filtering input power on a power line with a first filter with a first end and a second end, said first end is operably connected in series with the first power input terminal, the second end is operably connected to a first output terminal; and forming an impedance comprising a first conductor on a first layer of a circuit card forming a distributed inductance in series with the filter, the impedance also including a second conductor on a second layer of the circuit card operably connected to a ground, the first conductor and the second conductor forming a distributed capacitance wherein the impedance is configured to facilitate matching of an input impedance of the electromagnetic filter with that of a voltage source and the distributed inductance and the distributed capacitance cooperate to provide the filtering of electromagnetic interference.

The above discussed and other features and advantages of the present invention will be appreciated and understood by those skilled in the art from the following detailed description and drawings.

### BRIEF DESCRIPTION OF DRAWINGS

Referring to the exemplary drawings wherein like elements are numbered alike in the several Figures:

FIG. 1 depicts an existing EMI filter and surge suppressor apparatus;

FIG. 2 depicts an end view of a circuit card assembly for an exemplary EMI filter and surge suppressor apparatus;

FIG. 3 depicts a simplified view of a circuit card assembly for an exemplary EMI filter and surge suppressor apparatus; and

FIG. 4 depicts a schematic for an illustrative implementation of an exemplary embodiment.

### DETAILED DESCRIPTION

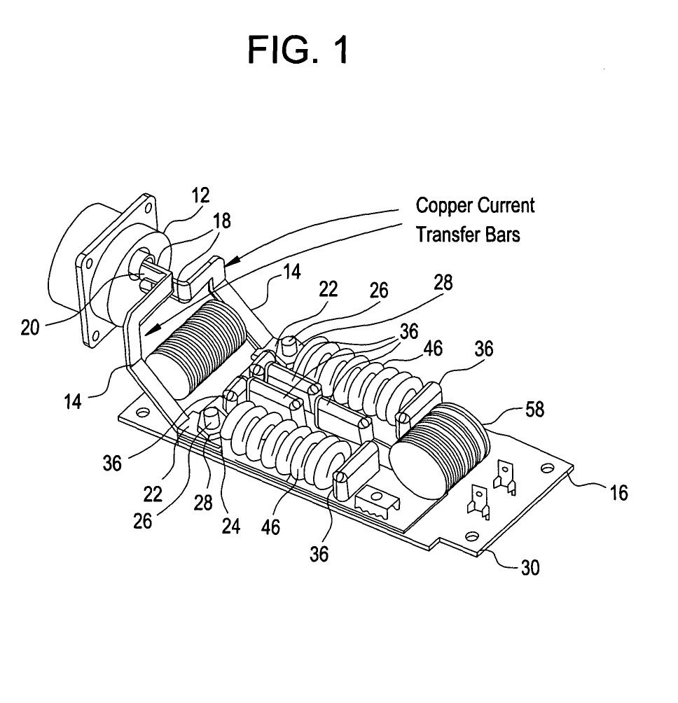

Referring first to FIG. 1, disclosed herein in an exemplary embodiment is a DC voltage surge suppression/EMI filter apparatus 10 hereinafter denoted as filter 10, with reduced component count and configured to provide predictable attenuation characteristics. The filter 10 is configured to provide consistent attenuation of unwanted radio frequency (RF) signals from about 200 kHz to about 1 GHz. Advantageously, over the existing designs, the filter 10 is also configured to take advantage of inherent capacitances and provide a determinable, reproducible capacitance that is also readily adjustable to various RF filtering requirements. In yet another exemplary embodiment, the filter provides a method of controlling impedance values for several elements and thereby ensuring matching various impedance requirements. Moreover, in yet another exemplary embodiment, the filter 10 eliminates the point-to-point wiring and selected discrete components of existing designs that were expensive and not accurately reproducible employing selected configurable interconnections the facilitate impedance matching and reduce connection resistance and thereby decreasing inherent heat generation.

Continuing now with FIG. 1, the filter 10 includes a connector 12 for interconnection to a power source (not shown) transfer/bus bar(s) 14, and circuit card assembly 16. The connector 12 may be of any configuration that may be interconnected with the transfer/bus bar(s) 14, a standard two pin, solder type circular receptacle is depicted. The transfer/bus bar(s) 14 (two are shown) provide a current path from the connector 12 to the circuit card assembly 16 of the filter 10. In an exemplary embodiment the transfer/bus bar(s) 14 are preformed conductive bus bars of substantially rectangular cross section readily attached to the connector 12 and circuit card assembly 16. The transfer/bus bar(s) 14 may be configured of any high conductivity material that may readily be formed as needed to fit the implementation. For example, while copper is used for and exemplary embodiment, other materials are possible including, but not limited to gold, silver, aluminum, and the like, as well as combinations or alloys including at least one of the foregoing. Moreover, while a rectangular cross section is described as an exemplary embodiment, it will be appreciated that many other cross sections or shapes are possible. In an exemplary embodiment the transfer/bus bar(s) 14 include a flat portion 18 to operably and mechanically interface with the pins/terminals 20 of the connector 12. Further, the transfer/bus bar(s) 14 includes another flat portion 22 disposed in a manner to be substantially coplanar with the circuit card assembly 16 and facilitate optimal conductive contact with a trace 24 thereon. In an exemplary embodiment, the transfer/bus bar(s) 14 are operably connected to the connector 12 with an electrically conductive solder connection and to the circuit card assembly 16 via a threaded stud 26 and nut 28. It will be appreciated that other configurations for attachment are readily available and possible. A threaded stud 26 and nut 28 is selected for an exemplary embodiment to facilitate optimal conductivity between the transfer/bus bar(s) 14 and the circuit card assembly 16 and facilitate assembly and disassembly. Another advantage of the transfer/bus bar(s) 14 of an exemplary embodiment is that the preformed configuration practically eliminates the mechanical strain to the circuit card assembly 16 inherent in existing configurations employing large wire/multi-wire interconnections with small bend radii. Yet, another advantage achieved by an exemplary embodiment is reduced variation in interconnection conductivity over life, and therewith power dissipated in the interconnections. In an exemplary embodiment, the number of crimped interconnections of the existing art are reduced, and thereby the power dissipated and subsequent heat generated is reduced.

Yet another advantage of an exemplary embodiment over the existing designs is a reduction in heat generated in the interconnections. In a high current application the increase of resistance in any part of the circuit can cause a rise in temperature. This phenomenon may be addressed by reducing the amount of interconnection points from the main power connector 12 to the circuit card assembly 16. The features and benefits of an exemplary embodiment may now be understood with reference to the analysis and equations provided herein.

It is well known that
P=I²R
where:
   P=power in Watts
   I=current in amps AC or DC (For this discussion consider DC only)
   R=Resistance in ohms.

By reducing contact resistance in the transfer of power to the circuit board assembly 16, the temperature of the operating circuit may readily be reduced. For example, consider a 3-inch long cable with two cables to connector-crimped connections. Even though the cable is very short, when placed into a circuit that can deliver high currents, e.g., about 50 ADC, the contact resistance of a connector-cable-connector can become significant. Therefore, by reducing the number of contact points, the resistive impedance is lowered and the temperature of the overall circuit is reduced. Moreover, It is will known that crimped connections have proven to exhibit 2-10 times more resistance due to oxidation at the crimped joint. Therefore, advantageously, if a joint is removed by eliminating the crimp, the system becomes more efficient. Therefore if Rₜ=R₁+R₂ . . . R_{X} and the resistance of three vs. two contact points may be readily computed. For a typical crimped joint, the contact resistance is initially, approximately 0.003 Ω (ohms). Over time, a an increase on the order of about 3 times that value, equaling 0.009 Ω (ohms) at each joint can be conservatively expected. In a three joint interconnection, this would be a total of 0.027 Ω (ohms) of resistance verses 0.018 Ω (ohms) in a two joint interconnection.

Using the formula for power as stated above, the three joint system delivering 50 ADC would be calculated as:
P=(50)²×0.027=67.5 Watts
dissipated as heat into the environment.

Using the same formula the two-joint/interconnection system would be:
P=(50)²×0.018=45 Watts
dissipated as heat. This is a 33% reduction in dissipated power when using a system with fewer joints.

Therefore, in an exemplary embodiment, the crimped interconnections are eliminated, resulting in reduction of the power dissipated in heat, and thereby a reduction in the thermal stress placed upon the components of the filter 12. Reduced stress on the components results in increased life for the filter 12.

In yet another exemplary embodiment, the transfer/bus bar(s) 14 are configured to exhibit substantially equivalent impedances, and thereby facilitate impedance matching with other elements of the filter 10. It will be appreciated that by substantially matching input impedances optimal signal transfer and filtering may be achieved. Prior configurations employing uncertain lengths of large wire gauge resulted in less controllable impedances. In an exemplary embodiment, the transfer/bus bar(s) 14, in this instance, copper, are placed in such a way to effectively match the impedance of the input cabling to the filtering circuit. This impedance matching is determined by:
Z_{q}=(ZₐZₗ)^{1/2}
where
Z_{q}=impedance of Q-matching section
Zₐ=impedance to be matched
Zₗ=line impedance
Known line impedance=150 ohms (for example)
Impedance to be matched=194 ohms (for example)
∴ Q=170 ohms

The geometry of the transfer/bus bar(s) 14 in combination with the controlled impedance of the copper strips (traces) 24 on the circuit board 30 actually yield 192 ohms that should present a standing wave ratio (SWR) of 1.010, With an implementation of an exemplary embodiment, at the frequency of interest an SWR of 1:1.0002 has been achieved.

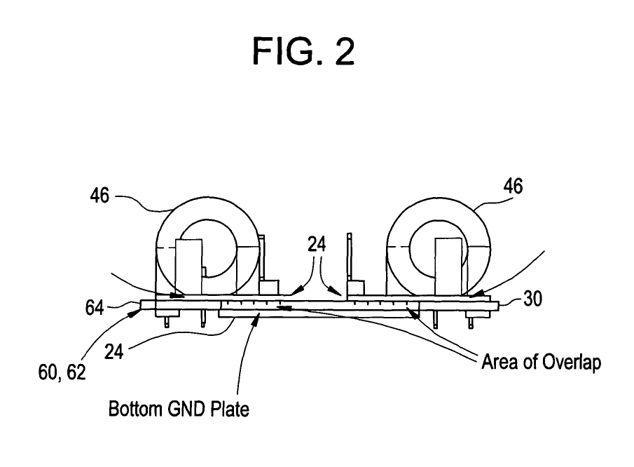

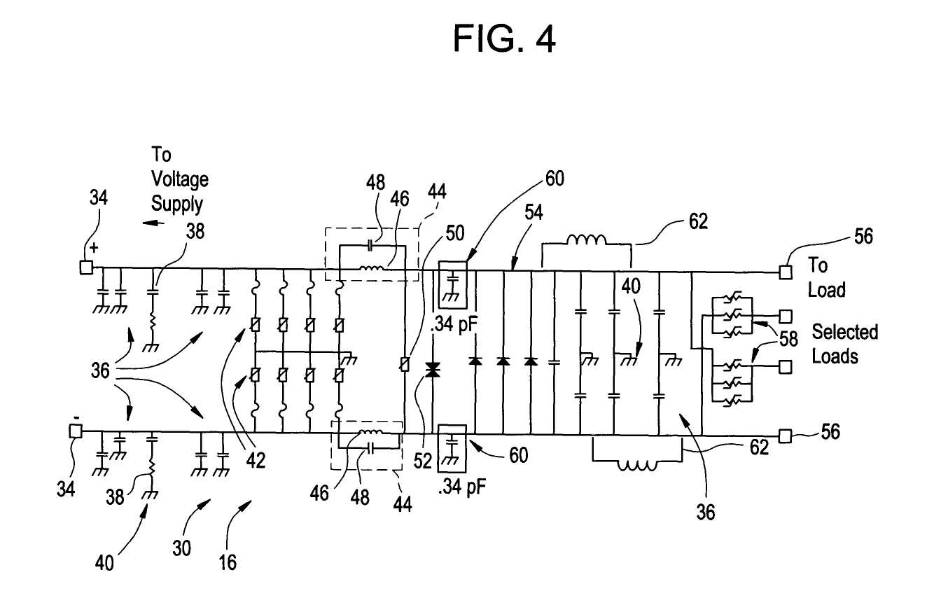

Continuing now with FIG. 1 and turning now to FIGS. 2-4 as well, additional details may now be considered with regard to the circuit card assembly 16 and the components thereon. The circuit card assembly 16 the filter 10 further includes components necessary to facilitate surge suppression and EMI filtering. Referring to FIG. 4 a schematic representative of an implementation for an exemplary embodiment is depicted. Referring to the figure, the power/current is applied at terminals 34, in this instance the also the traces 24 of the circuit board 30. To facilitate discussion of the advantageous feature of an exemplary embodiment, the filter 10 will be described with reference to a positive terminal and negative terminal to identify the potential reference for the components therein. It will be appreciated that such a reference is provided for convenience of description only and should not at all be considered limiting. The embodiments described herein are readily applicable to other power systems and filters whether of AC voltage and current or DC and of different polarity.

Continuing with the schematic of FIG. 4, a first filter including a plurality of capacitors 36 and resistor-capacitor (RC) filters 38 are employed to initially filter undesirable high frequency signal and noise from the power. The capacitors 36 and RC filters 38 are operably connected to shunt undesirable high frequency signal and noise from the power lines (from terminals 34) to chassis ground, shown generally as 40. A plurality of transient absorbers 42, in this instance, metal oxide varistors (MOV) are connected to shunt undesirable high voltage transients from the power lines to chassis ground 40. Once again, it will be appreciated that while in a described implementation of an exemplary embodiment, metal oxide varistors are identified as transient absorbers, such enumeration is illustrative only. Many other types transient absorption devices may be employed as mentioned earlier such as metal oxide varistors, other varistors, transorbs, transient suppression diodes, air gap devices, gas discharge devices, and the like, as well as combinations including at least one of the foregoing. It will be appreciated that the breakdown voltage of the transient absorbers 42 is selected to ensure that there is no significant conduction at normal operating voltages of the power source. In an exemplary embodiment, the transient absorbers are also depicted with fusible overcurrent protection, however it will be appreciated that other configurations are possible

The circuit card assembly 16 further includes a several components to formulate the surge suppressor and filter of another exemplary embodiment. The filter 10 also includes series trap filter 44 in series with the power source (one for each path of the current in an embodiment) e.g., the incoming power from a power source and the return. In an exemplary embodiment, the trap filter 44 includes, but is not limited to, a parallel combination of the coil(s) 46 and a capacitor 48. The coil 46 and capacitor 48 interact to form a high impedance over a selected range of frequencies. In an exemplary embodiment, the trap filter 44 is configured to block and attenuate frequencies over a range of about 75 KHz to about Hz. The coil(s) 46 may be formed as an air core inductor configured to readily pass DC or low frequency content of the source power, while providing a high impedance to high frequency signal content on conductors of the power input.

Continuing with the circuit card assembly 16 and the filter 10 further includes yet another transient absorption device 50 and 52 each operably connected across the voltage supply now on the load side of the trap filter(s) 44 described above. In an exemplary embodiment, a MOV and transient voltage surge suppression diode (TVSS) are employed. Once again, the breakdown voltage of the transient absorption device 50 and 52 is selected to ensure that there is no significant conduction at normal operating voltages of the power source. It will be appreciated that in many instances in the implementation described, similar devices are utilized in parallel, seemingly redundant. It is well-known design practice to do so, in order to address the varied transient characteristics of the devices. For example, in this instance a MOV and TVSS diode are utilized together to address the conduction response of one device and the power handling limitations of another

Continuing with the circuit card assembly 16 the filter 10 also includes reverse voltage protection. The reverse voltage protection may be implemented with fast recovery diode(s) 54 operatively connected to crow bar the voltage supply, activating load protection of the voltage source in the event of a reverse polarity connection. A plurality of capacitors, shown once again, generally as 36, are employed to filter any remaining undesirable high frequency signal and noise from the power to be supplied to a load (not shown). The capacitors 36 are operably connected to shunt undesirable high frequency signal and noise from the power lines and output terminals 56 to chassis ground, shown generally as 40. In yet another exemplary embodiment, additional protection is provided to selected loads (not shown) with one or more positive temperature coefficient device(s) 58 operably interconnected in series between the filtered voltage as available at output terminals 56 and the selected loads. The positive temperature coefficient device(s) 58 provide a low resistance below a selected current and temperature and higher resistance at higher current/temperature.

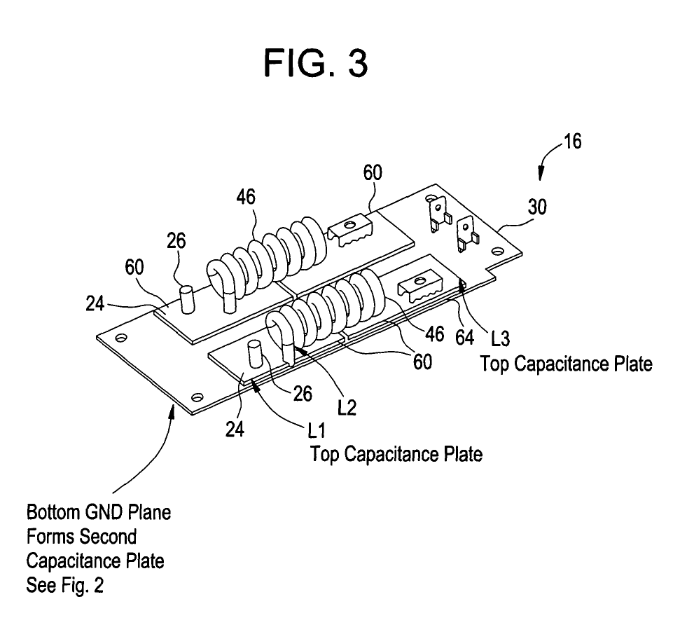

Continuing with the circuit card assembly 16 of the filter 10 also includes a distributed capacitance and inductance that contribute to formulate the surge suppressor and filter 10 of yet another exemplary embodiment. The distributed capacitance 60 and distributed inductance 62 are depicted in the schematic of FIG. 4 as single entities for simplicity of depiction and discussion. In actuality, the distributed capacitance 60 and distributed inductance 62 is formed over the surface area of selected circuit board traces 24 on the circuit card 30. Continuing with FIGS. 2 and 3 for a more detailed observation concerning the formation of distributed capacitance 60 and distributed inductance 62. In an exemplary embodiment, the distributed capacitance 60. FIG. 2 depicts a simplified perspective view of the circuit card assembly 16 with primarily the circuit card 30, traces 24, and coil(s) 46 depicted. FIG. 3 provides an end view of the circuit card assembly to facilitate depiction of the overlapping of traces 24 on the circuit card 30.

In an exemplary embodiment, the distributed capacitance is formed by a trace 24 on one layer of the circuit card 30 and another trace on another layer of the circuit card 30 forming a parallel plate capacitor with the circuit card material 64 acting as a dielectric. It is also noteworthy to appreciate that while the distributed capacitance is depicted as being “downstream” (closer to the load) of the trap filter 44, in actuality, a portion of the distributed capacitance is configured to be prior to the trap filter 44. Similarly, in an exemplary embodiment the distributed inductance 62 is formed based on the inherent inductance of the trace 24 on the circuit card assembly 16. It is will known that all conductors when carrying a current exhibit an inherent inductance. In an exemplary embodiment, the filter 10 takes advantage of this inherent inductance to facilitate the filtering required.

The features and benefits of an exemplary embodiment may now be understood with reference to the analysis and equation provided herein. For the distributed capacitance 60, it will be appreciated that when two metal plates are stacked one on the other with a dielectric material between them, there will exist an inherent capacitance. Since one means of removing electromagnetic interference (EMI) is via the utilization of capacitance and inductance in a resonant circuit, an exemplary embodiment as disclosed herein uses the capacitance formed from two copper layers of the printed circuit board 30 (PCB) separated by the PCB material as a dielectric. The capacitance in farads may then be determined as:
C=0.2244kA/d (1)
Where
   k=dielectric constant of dielectric between plates=4.7 for FR-4-PCB material
   A=area of one plate in square inches
   d=distance between plates (in.).

In this case, the overlap of plates yields 33.85 pF (picoFarads) of capacitance per square inch.

Likewise, as stated earlier, an exemplary embodiment takes advantage of the inherent inductance provided by the traces 24 of the circuit board 30. A flat metal plate placed on a substrate (PCB) exhibits an inherent inductance determined by the geometry thereof. For a simple example of a rectangular geometry, this inductance in micro-Henrys may be determined as:
L=0.0021[2.303 log₁₀(2 l/b+c)+0.5+0.2235(b+c)/l] L=500 nH (Measured)
where
b=one side of rectangle (cm)
c=other side of rectangle (cm)
l=length of conductor (cm).

The inductances of each of the conductive paths are calculated from the formula given above. In this case, the geometry identified above yields an inductance of 52 (nanoHenries) nH. In an exemplary embodiment, this inductance may readily be combined with the inductance of the coil 46 in the trap filter 44, in an exemplary embodiment, 500 nH yielding 552 nH per current path. This inductance is then combined with the inherent capacitance explained earlier to form a low pass filter that attenuates frequencies below this point of resonance.

The resonant frequency of the combination of inductance and capacitance is determined by:
f=½π\sqrt{LC}
which calculates to a resonant frequency of approximately 37 MHz.

It will be appreciated that the use of first and second or other similar nomenclature for denoting similar items is not intended to specify or imply any particular order unless otherwise stated.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electromagnetic interference filtering apparatus comprising:
a first filter with a first end and a second end, said first end is operably connected in series with said first power input terminal, said second end is operably connected to a first output terminal; and
an impedance comprising a first conductor on a first layer of a circuit card forming a distributed inductance in series with said filter, said impedance also including a second conductor on a second layer of said circuit card operably connected to a ground, said first conductor and said second conductor forming a distributed capacitance, and wherein said impedance is configured to facilitate matching of an input impedance of the filtering apparatus with that of a voltage source and said distribute inductance and said distributed capacitance cooperate to provide filtering of electromagnetic interference.

2. The apparatus of claim 1 further including a second filter operably connected to a first power input terminal and a ground;

3. The apparatus of claim 1 wherein said second filter comprises a first capacitor and a second capacitor, each capacitor with a first end and a second end, wherein said first end of said first capacitor is operably connected to said first power input terminal and said second end is operably connected to a ground and wherein said first end of said second capacitor is operably connected to said second power input terminal and said second end is operably connected to said ground.

4. The apparatus of claim 1 further including a third filter with a first end and a second end, said first end is operably connected in series with said second power input terminal and said second end is operably connected to a second output terminal; and

5. The apparatus of claim 4 further including another impedance comprising a third conductor on a first layer of a circuit card forming a distributed inductance in series with said third filter, said another impedance also including a fourth conductor on a second layer of said circuit card operably connected to a ground, said third conductor and said fourth conductor forming a distributed capacitance, and wherein said impedance is configured to facilitate matching of an input impedance of the filtering apparatus with that of a voltage source.

6. The apparatus of claim 1 further including a fourth filter.

7. The apparatus of claim 6 wherein said fourth filter comprises a fourth capacitor and a fifth capacitor, each capacitor with a first end and a second end, wherein said first end of said fourth capacitor is operably connected to said first output terminal and said second end is operably connected to a ground and wherein said first end of said fifth capacitor is operably connected to said second output terminal and said second end is operably connected to a ground.

8. The apparatus of claim 1 further including at least one of: a first bus bar operably connected to said first power input terminal and said circuit card; and a second bus bar operably connected to said second power input terminal and said circuit card, said first bus bar and said second bus bar comprising a preformed conductor.

9. The apparatus of claim 8 wherein said first and second bus bars are configured to conduct current from an input connector to said circuit card, said first and said second bus bars including a flat portion to facilitate conduction with a conductor of said circuit card.

10. The apparatus of claim 8 wherein said first and second bus bars are configured to substantially eliminate strain exerted on said circuit card.

11. The apparatus of claim 8 wherein said first and second bus bars are configured to facilitate matching of an input impedance of the filtering apparatus with that of a voltage source.

12. The apparatus of claim 8 wherein said first and second bus bars are configured to eliminate cable to connector crimp connections to reduce power dissipation and heat generation.

13. The apparatus of claim 1 further including a first and a second of transient absorption devices each transient absorption device with a first end and a second end, wherein said first end of said first transient absorption device is operably connected to said first power input terminal and said second end is operably connected to a chassis ground and wherein said first end of said second transient absorption device is operably connected to said second power input terminal and said second end is operably connected to said chassis ground.

14. The apparatus of claim 1 further including a transient absorption device with a first end and a second end, wherein said first end of said first transient absorption device is operably connected to said first power terminal and said second end is operably connected to said second power terminal.

15. The apparatus of claim 1 further including a first and a second resistor-capacitor filter comprising a series combination of a resistor and a capacitor, each resistor-capacitor filter with a first end and a second end, wherein said first end of said first resistor-capacitor filter is operably connected to said first power input terminal and said second end is operably connected to a chassis ground and wherein said first end of said second resistor-capacitor filter is operably connected to said second power input terminal and said second end is operably connected to a chassis ground.

16. The apparatus of claim 1 wherein said first and second power terminal corresponding to a voltage source and a ground reference.

17. The apparatus of claim 1 wherein said first filter comprises an inductance and capacitance operably connected in parallel.

18. The apparatus of claim 1 further including a third and a fourth transient absorption device each transient absorption device with a first end and a second end, wherein said first end of said first transient absorption device is operably connected to said first output terminal and said second end is operably connected to a chassis ground and wherein said first end of said second transient absorption device is operably connected to said second output terminal and said second end is operably connected to said chassis ground.

19. The apparatus of claim 1 further including another transient absorption device with a first end and a second end, wherein said first end of said first transient absorption device is operably connected to said first output terminal and said second end operably connected to said second output terminal.

20. The apparatus of claim 1 further including a first and a second positive temperature coefficient device, each positive temperature coefficient device with a first end and a second end, wherein said first end of said first positive temperature coefficient device is operably connected to said first output terminal and said second end is operably connected to a load and wherein said first end of said second positive temperature coefficient device is operably connected to said second output terminal and said second end operably connected to said load.

21. The apparatus of claim 1 further including a connector in operable communication with said first power input terminal.

22. A method of filtering and matching impedance in a power line electromagnetic interference filter and surge suppression apparatus comprising:
filtering input power on a power line with a first filter with a first end and a second end, said first end is operably connected in series with said first power input terminal, said second end is operably connected to a first output terminal; and
forming an impedance comprising a first conductor on a first layer of a circuit card forming a distributed inductance in series with said filter, said impedance also including a second conductor on a second layer of said circuit card operably connected to a ground, said first conductor and said second conductor forming a distributed capacitance wherein said impedance is configured to facilitate matching of an input impedance of the electromagnetic interference filter with that of a voltage source and said distributed inductance and said distributed capacitance cooperate to provide filtering of electromagnetic interference.

23. The method of claim 22 further including filtering with a second filter operably connected to a first power input terminal and a ground;

24. The method of claim 22 wherein said second filter comprises a first capacitor and a second capacitor, each capacitor with a first end and a second end, wherein said first end of said first capacitor is operably connected to said first power input terminal and said second end is operably connected to a ground and wherein said first end of said second capacitor is operably connected to said second power input terminal and said second end is operably connected to said ground.

25. The method of claim 22 further including filtering with a third filter with a first end and a second end, said first end is operably connected in series with said second power input terminal and said second end is operably connected to a second output terminal; and

26. The method of claim 25 further including forming another impedance comprising a third conductor on a first layer of a circuit card forming a distributed inductance in series with said third filter, said another impedance also including a fourth conductor on a second layer of said circuit card operably connected to a ground, said third conductor and said fourth conductor forming a distributed capacitance wherein said impedance is configured to facilitate matching of an input impedance of the electromagnetic interference filter with that of a voltage source.

27. The method of claim 22 further including filtering with a fourth filter

28. The method of claim 27 wherein said fourth filter comprises a fourth capacitor and a fifth capacitor, each capacitor with a first end and a second end, wherein said first end of said fourth capacitor is operably connected to said first output terminal and said second end is operably connected to a ground and wherein said first end of said fifth capacitor is operably connected to said second output terminal and said second end is operably connected to a ground.

29. The method of claim 22 further including at least one of connecting said first power input terminal and said circuit card with a first bus bar; and connecting second power input terminal and said circuit card with a second bus bar, at least one of said first bus bar and said second bus bar comprising a preformed conductor.

30. The method of claim 29 wherein said connecting includes configuring said first and second bus bars to conduct current from an input connector to said circuit card, said first and said second bus bars including a flat portion to facilitate conduction with a conductor of said circuit card.

31. The method of claim 29 wherein said connecting includes configuring said first and second bus bars to substantially eliminate strain exerted on said circuit card.

32. The method of claim 29 wherein said connecting includes configuring said first and second bus bars to facilitate matching of an input impedance of the electromagnetic interference filter with that of a voltage source.

33. The method of claim 30 wherein said connecting eliminates cable to connector crimp connections to reduce power dissipation and heat generation.

34. The method of claim 22 further including suppressing transients with a first and a second of transient absorption devices each transient absorption device with a first end and a second end, wherein said first end of said first transient absorption device is operably connected to said first power input terminal and said second end is operably connected to a chassis ground and wherein said first end of said second transient absorption device is operably connected to said second power input terminal and said second end is operably connected to said chassis ground.

35. The method of claim 22 further including absorbing transients with a transient absorption device with a first end and a second end, wherein said first end of said first transient absorption device is operably connected to said first power terminal and said second end is operably connected to said second power terminal.

36. The method of claim 22 further including filtering with a first and a second resistor-capacitor filter comprising a series combination of a resistor and a capacitor, each resistor-capacitor filter with a first end and a second end, wherein said first end of said first resistor-capacitor filter is operably connected to said first power input terminal and said second end is operably connected to a chassis ground and wherein said first end of said second resistor-capacitor filter is operably connected to said second power input terminal and said second end is operably connected to a chassis ground.

37. The method of claim 22 wherein said first and second power terminal corresponding to a voltage source and a ground reference.

38. The method of claim 22 wherein said first filter comprises an inductance and capacitance operably connected in parallel.

39. The method of claim 22 further including absorbing transients with a third and a fourth transient absorption device each transient absorption device with a first end and a second end, wherein said first end of said first transient absorption device is operably connected to said first output terminal and said second end is operably connected to a chassis ground and wherein said first end of said second transient absorption device is operably connected to said second output terminal and said second end is operably connected to said chassis ground.
